(19) United States
(12) Patent Application Publication
(10) Pub. No.: US 2009/0309966 A1
(43) Pub. Date: Dec. 17, 2009

(54) METHOD OF DETECTING MOVING OBJECTS

(76) Inventors: Chao-Ho Chen, Tai-Nan City (TW); Yu-Feng Lin, Kaohsiung City (TW)

Correspondence Address: NORTH AMERICA INTELLECTUAL PROPERTY CORPORATION, P.O. BOX 506, MERRIFIELD, VA, 22116, US

(21) Appl. No.: 12/352,586

(22) Filed: Jan. 12, 2009

(30) Foreign Application Priority Data
Jun. 16, 2008 (TW) 097122400

(51) Int. Cl. H04N 7/18

(52) U.S. Cl. 348/135; 348/E07.085

(57) ABSTRACT

A method for detecting moving objects includes: (a) capturing and establishing a background image; (b) capturing at least one current image; (c) transforming the background image and the current image from an RGB color format into an HSI color format; (d) subtracting the background image from the current image according to a background subtraction rule for generating at least one moving object; (e) performing a vertical scanning and a horizontal scanning on the moving object for generating a minimum bounding box of the moving object; (f) calculating a characteristic datum of the moving object according to the minimum bounding box; (g) tracking the moving object according to the characteristic datum with a Euclidean distance rule; (h) classifying the moving object according to the characteristic datum, the tracking result generated by step (g) and a minimum distance classifier.

### BACKGROUND OF THE INVENTION

1. Field of the Invention

The present invention relates to a detecting method, and more specifically, to a method of detecting moving objects.

2. Description of the Prior Art

In recent years, traffic surveillance systems have been put forward extensively for discussion and study because they provide meaningful and useful information, such as data on speed limit violations and other traffic infractions. An ITS (Intelligent Transportation System) is one of the most representative examples. The ITS integrates communication, control, electronic, and information technologies to make most efficient use of limited transportation resources to increase quality of life and economic competitiveness.

The ITS technology comprises microelectronics, automatic artificial intelligence, sensors, communications, control, and so on. Another important technology is computer vision. Since efficient operation of the ITS depends on accurate real-time traffic parameters, the image processing and computer vision applications not only make the ITS less expensive and more convenient in use, but also make the ITS capable of performing the measurement and surveillance process on a larger area to obtain more diverse information, such as vehicle-flow, vehicle speeds, traffic jams, infracting vehicle-tracking, quick detection of traffic accidents, and so on.

Recently, with development of computer technology, the information transmission of the road surveillance is no longer uni-directional. Instead, with development of image processing, various related applications appear accordingly for providing many kinds of surveillance image information. However, signal decay and noise disturbance may occur during the information transmission, and various environmental factors, such as ambient light influence on cameras, limit the use of the related algorithms.

In many algorithms and applications for image processing, the first step is to extract areas of interest from an image, meaning that the image may be divided into an area including moving objects and remaining areas for subsequent analysis and statistics, such as human face identification, license plate identification, passenger flow counting, vehicle-counting, and so on. The objective of the first step is to separate human faces, license plates, passengers, and vehicles from the background image. In summary, an appropriate object detection algorithm and the integrity of the detected object may influence the estimation and the accuracy of the processing algorithms in the subsequent steps.

Common algorithms for object detection are mainly divided into three kinds: a background subtraction method, an adjacent image difference method, and an optic flow method. The related description is provided sequentially as follows.

The background subtraction method involves performing a difference operation on a background image with no moving objects and a current image in a field of view and performing a two-valued operation on the difference result to obtain an area with moving objects. As shown in equation (1), frame(x, y, t), BG(x, y), and BI(x, y, t) denote the image at the time “t”, the background image, and the binary image respectively. This is a simple and efficient method, but it cannot efficiently overcome some environmental factors, such as light variation, noise disturbance, shadow variation, camera vibration, and so on. Thus, for reducing the detection errors caused by the said problems, many models for background update and algorithms for establishing a background model appear accordingly so that the background image may be established and updated timely to obtain a better area with moving objects.

$$BI ( x , y , t ) = \{ \begin{matrix}255 , & if \vert frame ( x , y , t ) - BG ( x , y ) \vert > T \\ 0 , & if \vert frame ( x , y , t ) - BG ( x , y ) \vert \leq T\end{matrix} \qquad equation ( 1 )$$

Next, the adjacent image difference method is described as follows. Since video signals are composed of a continuous image set, most image contents are similar in the adjacent images. The contents having a larger variation range lie in an area with moving objects. The adjacent image difference method involves performing a difference operation and a two-valued operation sequentially on two adjacent images. As shown in equation (2), frame(x, y, t), BG(x, y), and BI(x, y, t) denote the image at the time “t”, the image at the time “t−1”, and the binary image respectively. The outline of the moving object may be extracted based on the said method. Subsequently, fractures and holes in the area with moving objects may be filled up by the related image processing methods for obtaining the integrated area. The said method has good robustness for environmental variation, but is incapable of detecting the moving object when it stops moving temporarily.

$$BI ( x , y , t ) = \{ \begin{matrix}255 , & if \vert frame ( x , y , t ) - frame ( x , y , t - 1 ) \vert > T \\ 0 , & if \vert frame ( x , y , t ) - frame ( x , y , t - 1 ) \vert \leq T\end{matrix} \qquad equation ( 2 )$$

Finally, the optic flow method involves detecting pixel brightness variation in video signals for obtaining motion vectors of the pixels. The obtained motion vectors of the pixels are used to represent velocities of the pixels, and the corresponding moving pixel groups are regarded as a motion detection area. The said method may not only detect moving objects or perform a tracking process without establishing a background image, but may also be performed on condition that the camera is moving. However, unobservable motion and false motion may not be detected and processed efficiently in this method. The so-called unobservable motion means that no obvious brightness variation appears inside a moving object so that the real motion of the moving object cannot be detected by the optic flow method. And, the false motion means that a wrong motion vector of a motionless object may be detected by the optic flow method when color information of the motionless object changes with sudden light variation. Thus, the motionless object may be mistaken for a moving object. Furthermore, number of calculations performed in the optic flow method is very high, since the related mathematic operations are performed on every pixel, and the optic flow method is very sensitive to noise disturbance and light variation in an image. Therefore, this method cannot be applied to an outdoor real-time image processing system.

Next, object tracking methods are introduced as follows. Common object tracking methods are mainly divided into two kinds: 2D tracking methods and 3D tracking methods. The major objective of an object tracking method is to find out correlations between moving objects in two adjacent images of an image sequence and maintain the correlations in the image sequence for the continuity and integration of the moving objects.

Before the object tracking method is performed, a model corresponding to a moving object may be established first. The model may be established based on the features of the moving object, such as shape, location, color, and so on. Subsequently, the foreground information obtained from the said motion detection area is added into the said model, and then the final moving object information may be extracted by the comparison result of current images and the model.

The main tracking algorithms for automatic vehicle information extraction are divided into four kinds: a 3D model based tracking method, a region-based tracking method, an active contour-based tracking method, and a feature-based tracking method. The related description is provided as follows.

The 3D model based tracking method involves utilizing the origin of coordinates to position a center of a moving object. The major objective of the 3D model based tracking method is to perform 3D description on the moving object via the said model. The accuracy of the 3D model based tracking method is relatively high, but its main drawback is that detailed geometry information of the moving object is needed to be stored in a comparing template. However, in practice, since detailed geometry information of vehicles, such as size, outline, and so on, are different from each other, and the vehicles may keep moving, it is difficult to obtain the detailed geometry information of the vehicles moving on a road.

The region-based tracking method involves tracking locations of variable areas (regarded as moving objects) in an image sequence. The tracking area kinds may be divided into three levels (from small to large): block, region, and group. Each level may be combined or decomposed. This method may track one single person or multiple people, since the combination or decomposition condition of each level may be designated based on level colors and level features. Thus, the tracking disturbance problem caused by the object overlapping phenomenon may be avoided. This method may be applied to a road with a regular vehicle-flow. However, different vehicles may be incapable of being separated to track when a large vehicle-flow appears on the road.

The active contour-based tracking method, in which a moving object is expressed by its contour, involves endowing the contour of the moving object with characteristics of an image space, such as image edge or shape. Subsequently, the contour of the moving object may be updated based on the extracted image information for tracking the moving object. Since this method only extracts the contour of the moving object instead of extracting other features of the moving object, the related calculation process may be simplified and the loading of the system may be reduced. Furthermore, this method may also have a stronger noise rejection ability. Since the real location of the moving object in the image may be calculated by this method, the tracking misjudgment problem caused by the two objects that are excessively close to each other may be avoided.

The feature-based tracking method, in which all kinds of component factors for forming a moving object are extracted, involves assembling the component factors into the feature information of the moving object via a statistical process or an analysis process, and then tracking the moving object via comparing the continuous images with the feature information. The said feature information may be divided into three kinds based on the feature constitutive components: global feature-based information (centroid, color, area, and so on), local feature-based information (line, apex, and so on), and dependence-graph-based information (structural change among features). However, the number of the feature information selected in this method may influence the efficiency of the related tracking system, and the problem of how to categorize the feature information into the right objects may also occur in this method.

Another research applied to the ITS provides a method of utilizing multiple cameras to monitor one single road and constructing complete 3D vehicle models. The classification and parameter extraction accuracy of this method is higher, but the related cost is also increased. Furthermore, another method of detecting vehicles via the shadows between the vehicles and a road is also provided. This method may obtain a good detection result, but the extracted features for vehicle classification are not enough.

In summary, all the said methods in the prior art have respective drawbacks. Especially in vehicle-tracking and classification, the analysis and segmentation accuracy of the said methods is not as ideal as expected.

### SUMMARY OF THE INVENTION

The present invention provides a method of detecting moving objects comprising: (a) capturing and establishing a background image; (b) capturing at least one current image; (c) transforming the background image and the current image from an RGB color format into an HSI color format; (d) subtracting the background image from the current image according to a background subtraction rule for generating at least one moving object; (e) performing a vertical scanning and a horizontal scanning on the moving object for generating a minimum bounding box of the moving object; (f) calculating a characteristic datum of the moving object according to the minimum bounding box; (g) tracking the moving object according to the characteristic datum with a Euclidean distance rule; and (h) classifying the moving object according to the characteristic datum, the tracking result generated by step (g) and a minimum distance classifier.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a setup diagram of the system according to the present invention.

FIG. 2 is a flowchart of the system in FIG. 1.

FIG. 3 is a flowchart of the method of detecting moving objects according to the present invention.

FIG. 4 is a diagram showing the searching of the binary median filter.

FIG. 5 is a flowchart of processing the inner holes in the foreground area.

FIG. 6 is a diagram showing the result of performing the step 1 in the multi-object segmentation.

FIG. 7 is a diagram showing the result of performing the step 2 in the multi-object segmentation.

FIG. 8 is a diagram showing the result of performing the step 3 in the multi-object segmentation.

FIG. 9 is a flowchart of the algorithm for tracking the moving object according to the present invention.

FIG. 10 is a flowchart of the object classification according to the present invention.

FIG. 11 is a diagram showing the result of performing the object classification based on the aspect ratio according to the present invention.

### DETAILED DESCRIPTION

The present invention involves utilizing a real-time system to extract traffic parameters. The main method is to extract features of the moving vehicle via image processing technology so as to know vehicle states in a surveillance area. Subsequently, the necessary traffic parameters may be further provided to post processing of the ITS.

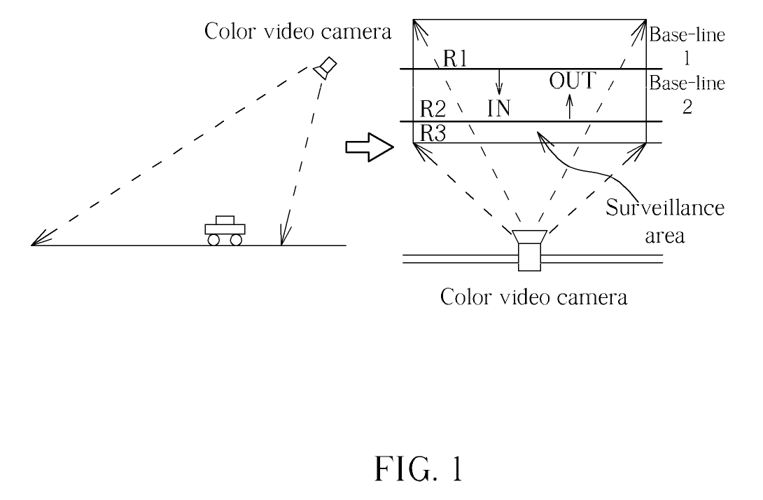

Please refer to FIG. 1. The major objective of a real-time vehicle-flow analyzing and counting system according to the present invention is application to a traffic-surveillance system. Therefore, a surveillance camera setup scheme in the present invention is like a common camera setup scheme on a road for capturing vehicle-flow images, and two base-lines are set in the said images for detecting moving directions of vehicles and extracting vehicle-flow data.

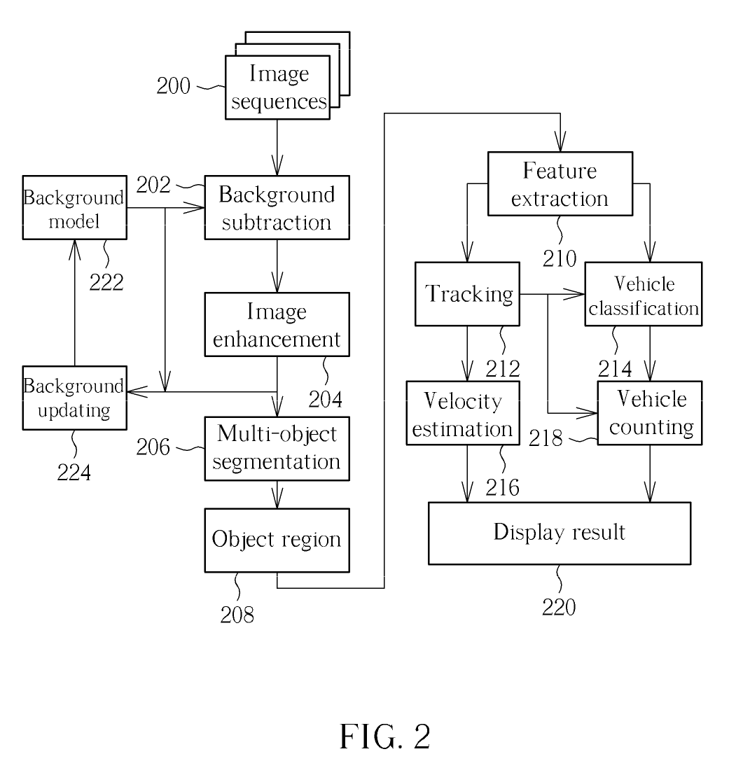

Next, please refer to FIG. 2. The method of the present invention may be divided into three procedures: moving object detection, vehicle classification, and vehicle-tracking. The said related results may be applied to vehicle-counting and velocity estimation of the tracked vehicles for extracting vehicle-flow parameters of the road.

Moving object detection: The system of the present invention utilizes extraction of moving objects from a fixed background according to differences between current images and a background image. However, shadow variation, noise disturbance, and brightness variation in the images may influence the efficiency of the background subtraction method greatly. Thus, in this procedure, both a noise reduction process and a morphological operation process will be further utilized to remove the said image interferences for extracting the moving objects.

Vehicle-tracking: The tracking method of the present invention based on features of the related vehicle geometry ratio involves determining whether vehicles in two successive images are alike or not. Furthermore, the minimum distance between the vehicles in two successive images may be measured based on the Euclidean distance rule for extracting the correlation of the vehicles in two successive images of an image sequence.

Object classification: The system of the present invention utilizes features of moving objects, such as area, perimeter, degree of dispersion, aspect ratio, and a minimum distance classifier to divide the moving objects into two categories: cars and bikes. Subsequently, the system of the present invention may also perform a counting operation on the said two categories for obtaining the vehicle-flow data and for the convenience of the subsequent tracking.

Vehicle-flow parameter extraction: The system of the present invention may count the number of the vehicles based on whether the centroids of the vehicles pass across the said base-line in the image or not. As shown in FIG. 1, when a vehicle moves from the R3 area to the R1 area, the vehicle is counted as “Out”. Otherwise, the vehicle is counted as “In”. At the same time, the image frames involving the vehicle when passing through the R2 area are also counted and the count is denoted as Fₙ. The instantaneous velocity v of the vehicle passing across the base-line may be calculated based on equation (3), in which S is the real distance between two base-lines and F is the frame number being recorded per second for the video. Besides, the vehicles are classified into two types according to the vehicle size, where a large-size vehicle indicates a car and a small-size vehicle means a bike. To predict if there is a traffic-jam situation, the vehicle-flow data will be estimated by counting both cars and bikes.

$$v = \frac{S \times F}{{F}_{n}} \qquad equation ( 3 )$$

After the said procedures, the vehicle-flow data extracted by the system may be displayed on the surveillance images so as to make it convenient for a user to observe the surveillance images and the vehicle-flow data at the same time, and the related vehicle-flow data may also be recorded in a database as a basis of the future vehicle-flow data.

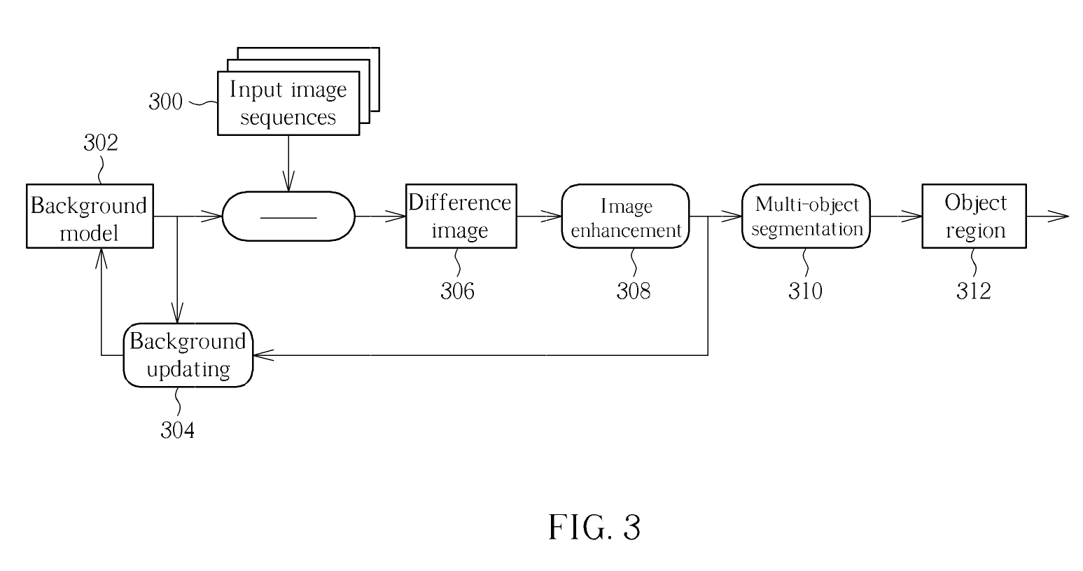

First, more detailed description for moving object detection is provided as follows. In many related researches for image processing and computer vision, the processing objective is focused on moving objects (foreground objects) in a visual range. A correct location and other related information of a target may be provided. In the present invention, the major objective is to monitor moving vehicles in the surveillance area. The first step is to detect moving objects. In general, the traffic-camera is usually set at a certain site (such as a traffic light or a street light) and hence the background image is stationary. For this reason, the present invention may utilize a background subtraction method to extract the moving objects from the background image and reduce interference (such as shadows and noise) that may appear in the background image. The related flowchart is shown in FIG. 3. The concept of the background subtraction method is to determine whether a pixel is a background pixel based on the appearance probability (AP) of the pixel. Thus, a background image may be established based on the statistic result of n images.

Before the background image has been established, some initialization processes are necessary. First, a reference matrix, μ(x, y, c), is set. In the initial image input stage, the first image is inputted into the reference matrix, meaning μ(x, y, c)=f(x, y, 0). At this time, a class variance, σ²(x, y, 0), is equal to 0, and both of a counter, rc(x, y, 0), and a total number of classes, nc(x, y), are equal to 1. As a result, the difference between the input image and the reference matrix may be calculated based on equation (4), expressed as follows.

AD(x, y, c)=|f(x, y, t)−μ(x, y, c)| equation (4)

At this time, if a minimal difference class “k” is selected and the minimal AD(x, y, k) is less than a threshold Th_{d}, the parameters rc(x, y, k), σ²(x, y, k), and μ(x, y, k) will be updated into the reference matrix according to equation (5). Otherwise, a new reference matrix is created by equation (6).

$$\begin{matrix}\{ \begin{matrix}μ ( x , y , k ) = \frac{rc ( x , y , k ) \times μ ( x , y , k ) + f ( x , y , t )}{rc ( x , y , k ) + 1} \\ {σ}^{2} ( x , y , k ) = \frac{1}{rc ( x , y , k ) + 1} \{ \begin{matrix}[ rc ( x , y , k ) \times {σ}^{2} ( x , y , k ) ] + \\ {\vert μ ( x , y , k ) - f ( x , y , t ) \vert}^{2}\end{matrix} \} \\ rc ( x , y , k ) = rc ( x , y , k ) + 1\end{matrix} & equation ( 5 ) \\ \{ \begin{matrix}rm ( x , y , nc ( x , y ) ) = f ( x , y , t ) \\ {σ}^{2} ( x , y , nc ( x , y ) ) = 0 \\ rc ( x , y , nc ( x , y ) ) = 1 \\ nc ( x , y ) = nc ( x , y ) + 1\end{matrix} & equation ( 6 )\end{matrix}$$

Based on a statistical result of n images, a reference model of the background image may be established. The AP of each pixel is expressed as equation (7).

$$AP ( x , y , c ) = \frac{rc ( x , y , c )}{{\sum }_{c = 0}^{nc ( x , y ) - 1} rc ( x , y , c )} = \frac{rc ( x , y , c )}{n} \qquad equation ( 7 )$$

After each class in the pixels is compared, the i-th class that has the highest AP may be classified as a candidate for the background pixel, and may be put into the reference model of the background image (as shown in equation (8)).

$$\{ \begin{matrix}i = arg {max}_{0 \leq c < nc ( x , y ) - 1} AP ( x , y , c ) \\ B ( x , y ) = μ ( x , y , i ) \\ {σ}^{2} ( x , y ) = {σ}^{2} ( x , y , i )\end{matrix} \qquad equation ( 8 )$$

where B(x, y) is the reference background of the pixel (x, y), and σ²(x, y) is the variance of background pixels.

After the said steps are executed, the background model is established and is adaptive.

When the adaptive background model is established, the moving objects may be detected based on the background subtraction method. In the present invention, detection of the moving objects is based on the gray-level images. Thus, the initial images may be transformed from an RGB color format to the intensity image of an HSI color format. The related equation is expressed as equation (9). The said background subtraction method involves taking a stationary background image as a reference image and subtracting the background image from a current image. As a result, a difference image is obtained. Subsequently, a moving area may be generated after performing a two-valued process on the difference image. The two-valued process is expressed as equation (10).

$$\begin{matrix}I = \frac{1}{3} ( R + G + B ) & equation ( 9 ) \\ D ( x , y , t ) = \{ \begin{matrix}255 , & if \vert {f}_{I} ( x , y , t ) - {B}_{I} ( x , y , t ) \vert > β σ ( x , y , t ) \\ 0 , & otherwise\end{matrix} & equation ( 10 )\end{matrix}$$

where the pixel is denoted as a foreground pixel if D(x, y, t) is equal to 255, and the pixel is denoted as a background pixel if D(x, y, t) is equal to 0. f_{I}(x, y, t) and B_{I}(x, y, t) denote the intensity information of the current image and background image at time t, respectively, σ(x, y, t) denotes the standard deviation of the pixel and β denotes a scaling parameter of the threshold value, which is an integer between 1 and 5.

When β is high, the noise reduction ability is much stronger, but the loss of the foreground pixels is also much higher. When β is low, the foreground area may be preserved more completely, but the noise pixels are also preserved accordingly. In the present invention, β is set to 3.

Furthermore, more detailed description for the background updating mechanism of the present invention is provided as follows. The major objective of the background updating mechanism is to establish a reliable background image in the input images so as to make the object detection more precise. However, as time goes by or when a moving object enters the surveillance image, the background image may be influenced inevitably. In this condition, the use of initial background model may incur errors in the object detection. For reducing the said errors, the background updating mechanism is necessary.

The present invention provides a method corresponding to the background updating mechanism. If there is a moving object in the surveillance image, the original background image, B(x, y, t), may be retained. On the contrary, if there is no moving object in the surveillance image, the current image, f(x, y, t), may be updated into the background image based on the rule of proportionality. This method may be achieved based on equation (11) and equation (12).

$$\begin{matrix}B ( x , y , t + 1 ) = \{ \begin{matrix}B ( x , y , t ) , & if D ( x , y , t ) = 255 \\ ( 1 - α ) B ( x , y , t ) + α f ( x , y , t ) , & if D ( x , y , t ) = 0\end{matrix} & equation ( 11 ) \\ {σ}^{2} ( x , y , t + 1 ) = \{ \begin{matrix}{σ}^{2} ( x , y , t ) , & if D ( x , y , t ) = 255 \\ ( 1 - α ) {σ}^{2} ( x , y , t ) + α {( f ( x , y , t ) - B ( x , y , t ) )}^{2} , & if D ( x , y , t ) = 0\end{matrix} & equation ( 12 )\end{matrix}$$

where α denotes the updating rate, and is between 0 and 1.

The surveillance camera of the present invention is set up on an overpass or a site above a street light for observing the traffic flow of the road. Thus, based on experimental rules, α is set to 0.05. The said background updating mechanism may overcome the problems of the slow change and the sunlight shining in the background image.

As mentioned above, a complete moving-area may be extracted based on the background subtraction method. However, stronger noise signals may also be preserved and cannot be removed, and broken edges and center holes may appear in the moving area since the color intensity of the inner part in the moving area is similar to that of the background image. If the said problems are not solved substantially, the subsequent feature extraction, object classification, and object tracking processes may be influenced greatly. Therefore, a plurality of methods may be provided to solve the said problems, such as morphological processing, noise reduction, and connect component labeling.

In the present invention, for recovering the original appearance of the moving area, a dilation process is firstly performed three times on the binary images and then a dilation process is also performed three times on that binary image. The major objective of the said processes is to connect the broken edges to the center broken regions in the moving area, and then perform an erosion process on the dilated moving area for recovering the original appearance of the moving area.

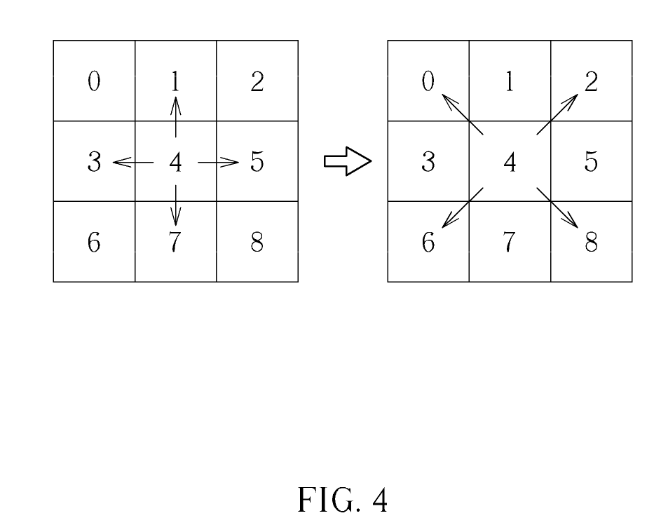

Next, more detailed description for the noise reduction is provided as follows. In image processing, a median filter is one of the filters commonly used for removing image noises. The median filter uses a n×n mask for filtering in an image to obtain pixels surrounding a certain pixel. In the present invention, the median filter is performed on the binary image. For deriving the desired result, an examination process is performed on vertical/horizontal pixels and then diagonal pixels sequentially. Take a 3×3 mask for an example. As shown in FIG. 4, the value of center pixel may be decided after the said examination process is performed at least five times.

Finally, the connect component labeling is described as follows. The major objective of the connect component labeling is to assign the same label to all pixels that are connected to each other in an image, and assign different labels to other differently connected components. In a binary image, this method may not only classify pixels, but also remove the non-target regions. A common connect component labeling process is to connect identical pixels and other different pixels sequentially to form a complete region. The main strategy is to utilize a 3×3 mask to scan the entire image horizontally, labeling the correlated pixels in the mask, and then connecting the pixels having the same label to form a complete region, in which pixels of each region have the same label.

The labeling processing rules are provided as follows.
if P5==0 then label (P5)=0, Pair=Null
else if label (P6)≠0 then label (P5)=label (P6)
if label (P7)≠0 then
if label (P7)≠label (P6) then Pair=[label(P6), label (P7)]
else Pair=Null
else if label (P8)≠0 then
if label (P8)≠label (P6) then Pair=[label (P6), label (P8)]
else Pair=Null
else if label (P9)≠0 then
if label (P9)≠label (P6) then Pair=[label (P6), label (P9)]
else Pair=Null
else if label (P7)≠0 then label (P5)=label (P7)
if label (P8)≠0 then Pair=Null
else if label (P9)≠0 then
if label (P9)≠label (P7) then Pair=[label (P7), label (P9)]
else Pair=Null
else if label (P8)≠0 then label (P5)=label (P8), Pair=Null
else if label (P9)≠0 then label (P5)=label (P9), Pair=Null
else label (P5)=New label , Pair=Null

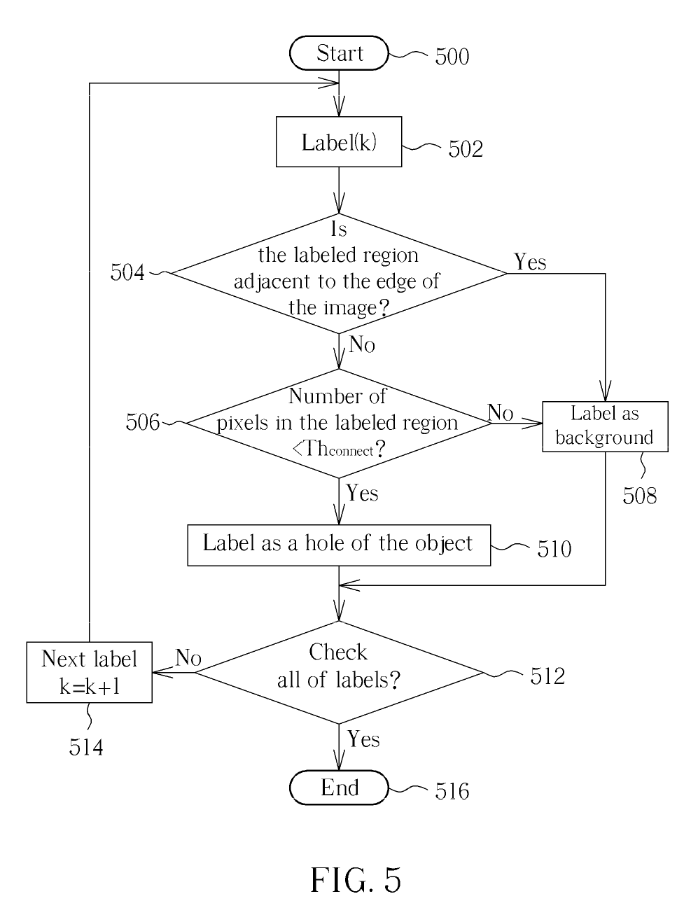

In the present invention, the labeling algorithm for performing the said connect component labeling operation on the binary image of background is shown in FIG. 5.

In the said operation, it is firstly to determine whether the labeled pixels are connected to the edge of the image. The part connecting to the edge of the image may be regarded as the background image (the value of the pixel is equal to 0). Next, an area-sized determination process may be performed on other labeled regions. If an area-sized of a region is less than a predetermined threshold value (Th_{connect}), the region may be regarded as an inner hole of the moving region and every pixel in such a region is filled up with a value of 255. If an area-sized of a region is greater than the predetermined threshold value, the region may be labeled as the background region. The related process is shown in FIG. 5. In such a manner, the inner holes of the moving region may be filled up for constructing a complete object mask with no hole.

After the system separates the foreground image from the background image, the objects in the foreground image need to be extracted one by one. However, the moving region may contain multiple moving objects, and hence a simple multi-object segmentation algorithm is employed to extract every moving object from the moving region. The method is expressed as follows.

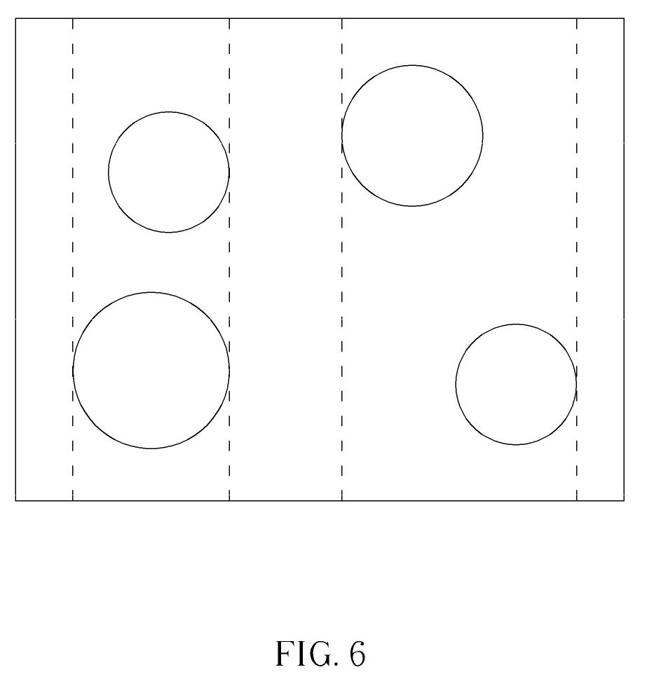

Step 1: Perform vertical scanning on the input binary image from left to right so that the image may be divided into multiple regions comprising moving objects, as shown in FIG. 6.

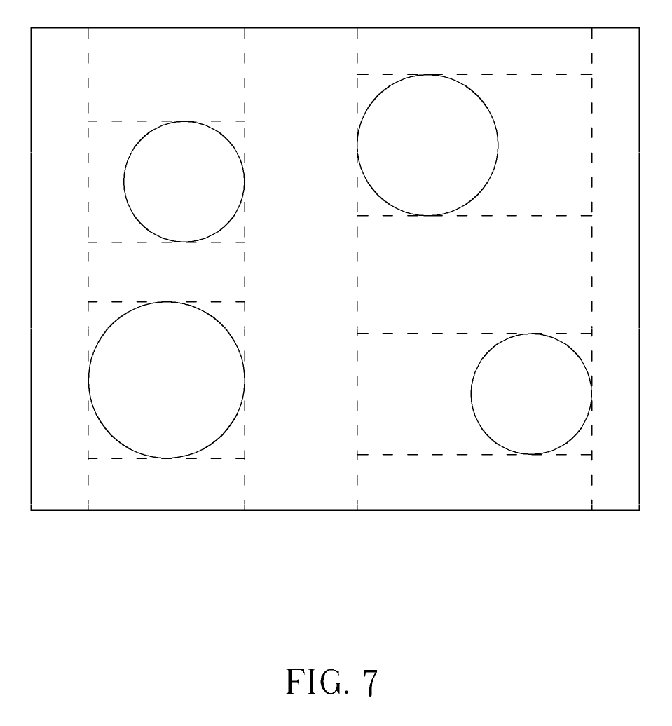

Step 2: Perform horizontal scanning on every region from upper to lower to extract the moving objects on the same vertical line, as shown in FIG. 7.

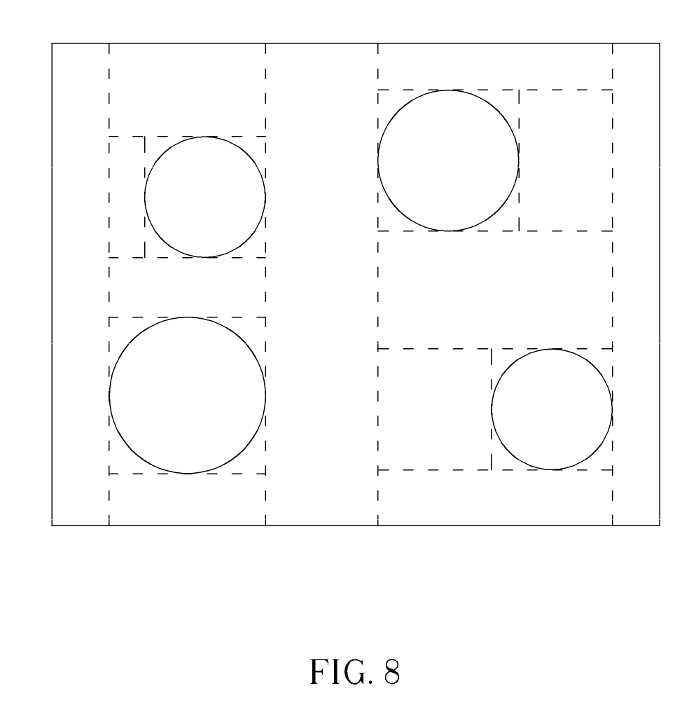

Step 3: Finally, perform vertical scanning again to extract a minimum bounding box of a moving object, as shown in FIG. 8.

After the said extraction process of the minimum bounding box of the moving object is finished, the next step is to perform the feature extraction and the object tracking.

First, the feature extraction is described as follows. In digital image analysis, many features may be utilized to represent an object, such as texture, color, shape, and so on. These features may be divided into two types: a space domain and a time domain. The space domain type means that these features may be utilized to discriminate different objects at the same time. The time domain type means that these features may be utilized to obtain the correlation among objects in a period of time from t to t+τ. In the present invention, based on the said mask and the minimum bounding box, the related features of the object may be extracted, such as length, width, area, perimeter, and so on.

How to get the mask and the minimum bounding box of the moving object is described in the aforementioned introduction. Next, according to the said information, the features of the moving object may be extracted as a feature basis of the object tracking and the object classification.

The perimeter and the area of the moving object are extracted most easily based on the minimum bounding box of the moving object. The related equations are expressed as follows.

$$\begin{matrix}Area = {\sum }_{( x , y ) ∈ object} 1 & equation ( 13 ) \\ Perimeter = {\sum }_{( x , y ) ∈ boundary} 1 & equation ( 14 )\end{matrix}$$

Furthermore, the vehicle classification and tracking may be achieved by the following feature extraction rules.

The perimeter and the area of the moving object may vary with the distance of the moving object and the surveillance camera. Thus, in feature analysis, some correlations exist between the size of perimeter and the area of the moving object and the distance between the moving object and the camera. Furthermore, for increasing the adaptability of the present invention, other features are discussed as follows.

A location of a centroid in an object may represent is the position of the object. The coordinate of the centroid in the object may be expressed as equation (15).

$${x}_{0} = \frac{{\sum }_{( x , y ) ∈ R} \sum x}{{\sum }_{( x , y ) ∈ R} \sum 1} , {y}_{0} = \frac{{\sum }_{( x , y ) ∈ R} \sum y}{{\sum }_{( x , y ) ∈ R} \sum 1} \qquad equation ( 15 )$$

Besides, the geometric characteristic of the moving object may be an important feature. It may represent the physical meaning of the object, such as aspect ratio and area ratio. The related equations are expressed as follows.

$$\begin{matrix}AspectRatio = \frac{Height}{Width} & equation ( 16 ) \\ AreaRatio = \frac{Area}{ROI} & equation ( 17 )\end{matrix}$$

where “Height” denotes the height of the minimum bounding box, “Width” denotes the width of the minimum bounding box, “Area” denotes the area of the object, “ROI” denotes the area of the minimum bounding box, and ROI=Height×Width.

Generally, no matter whether the moving object is rigid or not, the outline of the moving object may change frequently. Non-rigid objects, such as passengers, usually have rough or irregular outlines. Rigid objects, such as vehicles, usually have flat and regular outlines. A compactness of an object may represent the intense degree of pixels in the object mask. In many related researches, vehicles and passengers may be recognized efficiently according to the compactness feature. The related equation is expressed as follows.

$$Compactness = \frac{{Perimeter}^{2}}{Area} \qquad equation ( 18 )$$

The said feature parameters, such as width, height, area, perimeter and so on, may vary with the distance between the moving object and the surveillance camera. However, the variation of feature parameters may be reduced by using the ratio of the feature parameters. Since the said variation is the allowed tolerance in the experiment, the said features may increase the accuracy of the vehicle classification.

Next, more detailed description for the moving object tracking is provided as follows. The major objective of the moving object tracking is to extract the correlation between the detected objects in two successive images according to the said features. The said correlation information may increase the accuracy of the vehicle-counting and the velocity estimation.

In the present invention, the moving object tracking method is based on the said features.

The tracking rules of the present invention are described as follows.

1. Assume that the detected moving objects are the targets needing to be tracked.

2. Assume that the object list is empty initially. At this time, all the detected moving objects are added into the object list.

3. When there is an object shown in the object list, the object has two conditions:

the object has been recorded in the object list.
b. the object is not recorded in the object list. In this condition, the object needs to be added to the object list.

4. When the object in the object list can not be found in a current image, the object also has two conditions:

the object has moved away from the surveillance area or does not meet the detecting conditions.
b. the tracking fails. At this time, the object may be deleted from the object list.

5. If there is a new object in the object list after performing a feature matching process, the template information needs to be updated.

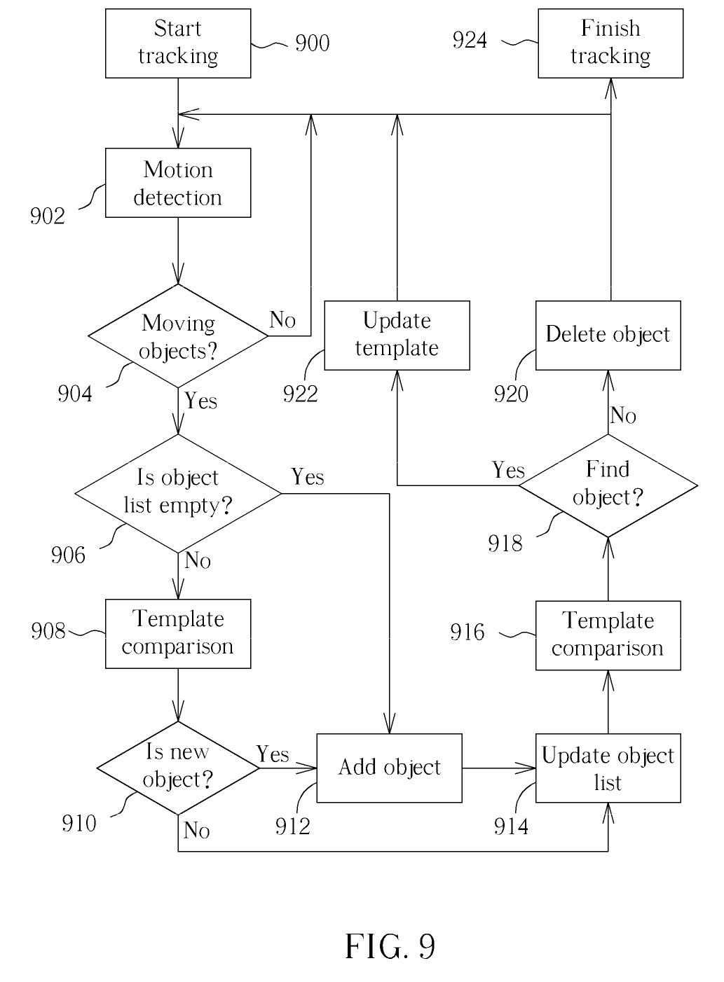

Based on the said assumptions and rules, the related flowchart of the moving object tracking method is shown in FIG. 9.

When the object moves, many features of the object may vary with different locations of the object. In the present invention, some feature variations are regular, such as aspect ratio. Thus, more detailed description for the aspect ratio of the moving object is provided as follows.

The aspect ratio of the vehicle changes little when the vehicle moves in the surveillance area. Thus, the aspect ratio of the vehicle may be regarded as one feature of the vehicle for the moving object tracking. Vehicles with excessive aspect ratio may be eliminated based on equation (19).

|AspectRatioₜ^{m}−AspectRatioₜ₋₁ⁿ|<Th_{Asp} equation (19)

where “m” and “n” denote the indexes of the object at time t and t−1, respectively, and Th_{Asp} is set to 0.15.

When the object is moving, the centroid coordinate of the object may vary anytime. However, the variation of the object's centroid between two adjacent images is very slight. The relative distances for each moving object located at two adjacent images may be measured based on the Euclidean distance rule, expressed as follows.

DIST(ctdₜ^{m},ctdₜ₋₁ⁿ)=\sqrt{(x₀ₜ^{m}−x₀ₜ₋₁ⁿ)²+(y₀ₜ^{m}−y₀ₜ₋₁ⁿ)²} equation (20)

where “m” and “n” denote the indexes of the object at time t and t−1, respectively.

At this time, when the distance is minimal and not greater than the threshold value, the object may be taken as the tracking candidate. The identical object in some successive images may be extracted according to the said two methods.

Next, more detailed description for the vehicle classification is provided as follows. Since there are only two lanes (fast lane and slow lane) labeled on a road, the vehicle classification method of the present invention may only divide the vehicles into two categories: cars and bikes.

In the prior art, a vehicle classification method is based on utilizing a feature threshold to classify the vehicles in a single reference image. Therefore, the misjudgment problem may arise when a vehicle starts to enter the surveillance area.

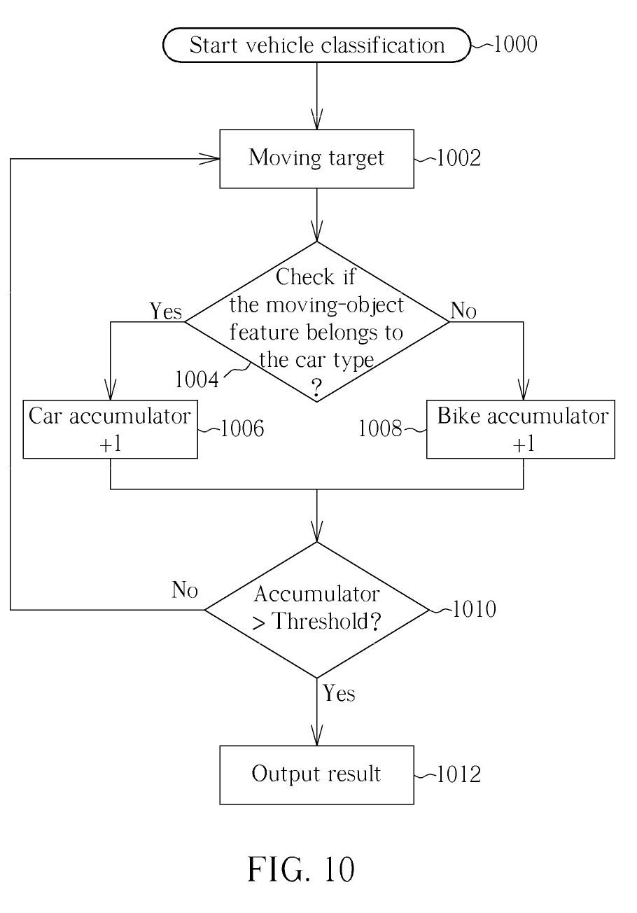

For solving the said problem, the present invention utilizes a vehicle classification accumulator to accumulate the vehicle tracking results. In a period of time, the vehicle classification is performed on every moving vehicle. When the feature of the moving object meets the condition of the car type, the car accumulator is incremented by 1. On the contrary, if the feature of the moving object meets the condition of the bike type, the bike accumulator is incremented by 1. Thus, the detected vehicles may be classified based on the accumulated results in the accumulators. The related flowchart is shown in FIG. 10. Although this method is time consuming, it may solve the said misjudgment problem.

Next, more detailed description for the decision theory applied to the vehicle classification is provided as follows. The decision theory involves utilizing a discrimination function. Assuming that x=(x₁, x₂, . . . , xₙ)^{T} denotes an n-dimensional vector, for W patterns types of ω₁, ω₂, . . . , ω_{W}, the major objective of the decision theory pattern is to find W discrimination functions d₁(x), d₂(x), . . . , d_{W}(x). If the said “x” conforms to the equation (21), the said “x” may be determined as the ωᵢ type.

dᵢ(x)>dⱼ(x)j=1, 2, . . . , W; j≠i equation (21)

In other words, for an unknown pattern “x”, if dᵢ(x) is maximal, “x” is determined as the i-th pattern. For separating the pattern ωᵢ and the pattern ωⱼ, the decision boundary may meet the condition that a set of “x” must conform to the equation (22).

dᵢ(x)=dⱼ(x) equation (22)

The equation (22) may be modified as equation (23).

dᵢⱼ(x)=dᵢ(x)−dⱼ(x)=0 equation (23)

At this time, the equation (23) may be utilized to determine the decision boundary between two categories: dᵢⱼ(x)>0 for the ωᵢ pattern and dᵢⱼ(x)<0 for the ωⱼ pattern.

The classification skill based on the match rule involves utilizing the original pattern vector to represent every category. An unknown pattern may be assigned to the nearest category in a predetermined measurement method. The simplest method is to utilize a minimum distance classifier, meaning that the minimum distance between the unknown pattern and each original pattern vector may be calculated for making a decision.

An original pattern vector of an object category is defined as an average vector of objects in the category.

$${m}_{j} = \frac{1}{{N}_{j}} {\sum }_{x ∈ {ω}_{j}} {x}_{j} , j = 1 , 2 , … , W \qquad equation ( 24 )$$

where Nⱼ denotes the sample number of the ωⱼ category, and W denotes the total number of the object categories.

The method of the present invention only divides the vehicles into two categories, i.e., W=2. Therefore, a method of assigning an unknown object to its category is to assign it to the category nearest to the original pattern vector based on its features. The distance to the original pattern vector may be determined based on the Euclidean distance rule. Thus, the vehicle classification may be simplified to the measurement of the distance.

Dⱼ(x)=∥x−mⱼ∥ equation (25)

The equation (25) may be modified as equation (26) based on a reference vector equation,

$$‖ a ‖ = {( {a}^{T} a )}^{\frac{1}{2}}$$

$${d}_{j} ( x ) = {x}^{T} {m}_{j} - \frac{1}{2} {m}_{j}^{T} {m}_{j} \qquad equation ( 26 )$$

If dᵢ(x) has the maximum value, “x” may be assigned to the ωᵢ category. For the minimum distance classifier, the decision boundary is expressed as equation (27).

$$\begin{matrix}{d}_{ij} ( x ) = {d}_{i} ( x ) - {d}_{j} ( x ) \\ = {x}^{T} ( {m}_{i} - {m}_{j} ) - 1 / {2}^{*} {( {m}_{i} - {m}_{j} )}^{T} ( {m}_{i} - {m}_{j} ) \\ = 0\end{matrix} \qquad equation ( 27 )$$

According to the said calculation process, a vertical bisector is employed for representing the decision boundary.

Next, according to the equation (25), the average aspect ratio, the average area ratio and the average compactness of a car are calculated as 1.461173, 0.840036, and 13.12123, respectively. In addition, the average aspect ratio, the average area ratio and the average compactness of a bike are calculated as 2.154313, 0.651516, and 17.12078, respectively. The sample number of the cars and bikes used as a basis of the calculated results are 375 and 431, respectively.

The present invention classifies the moving objects in the surveillance images according to the said calculated values. There are 317 moving object samples (138 cars and 178 bikes included) extracted from the surveillance images. For a fair evaluation in vehicle-counting, three situations of vehicle-flow with different moving directions are simulated: a bidirectional flow situation and two different uni-directional (forward direction and backward direction) flow situations.

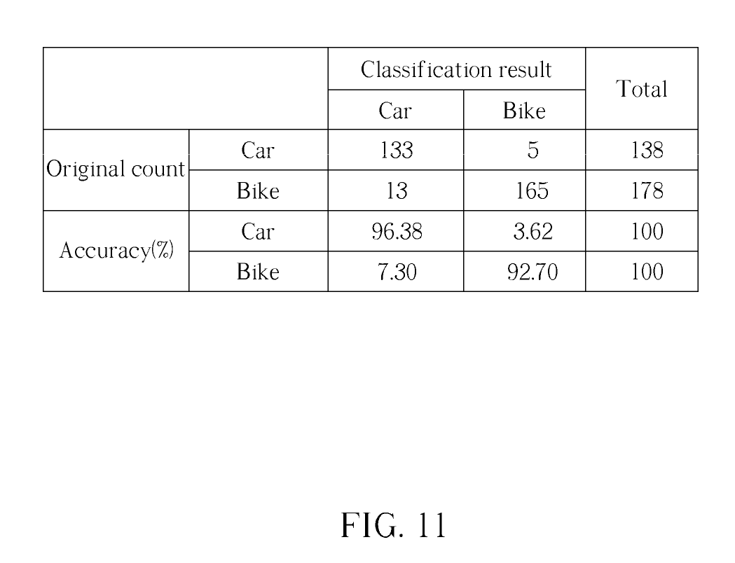

As experimental results show, the classification accuracy based on the aspect ratio feature is greater than 92%, as shown in FIG. 11.

Finally, more detailed description for the velocity estimation is provided as follows. The velocity formula in the kinematics is usually utilized for estimating the vehicle velocity. The related equation is expressed as follows.

$$\overline{v} = \frac{S}{Δ t} \qquad equation ( 28 )$$

where μ̅ denotes the average velocity, “S” denotes the distance of the surveillance area, and Δt denotes the time for passing through the surveillance area.

However, in the real velocity measurement, the instantaneous velocity ν is necessary, meaning that S approaches 0. For the current velocity measurement, a common method is to calculate the average velocity ν̅ of the object in a very short distance, and then take the average velocity ν̅ as the instantaneous velocity ν.

The distance measurement in an image captured by a camera involves an image forming geometry theory. The major objective of this theory is to transform 3D space in the real world into 2D image plane captured by the camera. Thus, the physical parameters and direction parameters of the camera are needed for calculating the real distance that a vehicle passes through.

Since the said parameter extraction is time consuming, the present invention utilizes equation (3) to calculate a vehicle velocity. By measuring the distance in the surveillance area and the frame rate of capturing, the velocity may be obtained.

In summary, the present invention provides an automatic vehicle classification and bi-directional vehicle-counting method dedicated to the real-time traffic surveillance system. First, the present invention utilizes the said statistic method to establish the background image based on the pixels with higher AP. Next, the initial mask of the moving object is extracted via subtracting of the said background image from the current image. Next, the median filter is utilized to remove most noises and small blobs, and then the morphological operations are utilized to refine the object mask. Next, in the minimum bounding box of the moving-object mask, the features of the moving-object are extracted for classifying those moving-objects according to the classification rule of the minimum distance classifier. The classification accuracy rate is greater than 90%. In the vehicle-tracking, the present invention takes the aspect ratio of the object and the centroid distance between two adjacent objects as a basis of the vehicle-tracking. For obtaining the vehicle-flow data, the present invention also counts the number of the vehicles and calculates the velocities of the vehicles based on the base-lines and the time that the vehicles pass through the surveillance area. Thus, compared with the prior art, the present invention may not only reduce the false-rate in the vehicle-tracking greatly, but also increase the accuracy rate in the vehicle classification considerably. The said vehicle-flow data may also make the post processing in the ITS more accurate.

Those skilled in the art will readily observe that numerous modifications and alterations of the device and method may be made while retaining the teachings of the invention.

What is claimed is:

1. A method of detecting moving objects comprising:
(a) capturing and establishing a background image;
(b) capturing at least one current image;
(c) transforming the background image and the current image from an RGB color format into an HSI color format;
(d) subtracting the background image from the current image according to a background subtraction rule for generating at least one moving object;
(e) performing a vertical scanning and a horizontal scanning on the moving object for generating a minimum bounding box of the moving object;
(f) calculating a characteristic datum of the moving object according to the minimum bounding box;
(g) tracking the moving object according to the characteristic datum with a Euclidean distance rule; and
(h) classifying the moving object according to the characteristic datum, the tracking result generated by step (g) and a minimum distance classifier.

2. The method of claim 1 further comprising:
updating the current image into the background image according to an updating rate when there are no moving objects in the current image.

3. The method of claim 2, wherein the updating rate is set to 0.05.

4. The method of claim 1 further comprising:
performing image enhancement for the moving object via a morphological processing method.

5. The method of claim 1 further comprising:
performing image enhancement for the moving object via a noise removing method.

6. The method of claim 1 further comprising:
performing image enhancement for the moving object via a connect component labeling method.

7. The method of claim 1, wherein step (f) comprises calculating perimeter, location of centroid, and aspect ratio of the moving object according to a boundary box of the moving object.

8. The method of claim 1, wherein step (h) comprises classifying the moving object into a car or a bike according to the characteristic datum, the tracking result generated by step (g) and a minimum distance classifier.

9. The method of claim 1, wherein step (g) comprises:
adding the moving object into an object list; and
comparing a plurality of current images captured in step (b) with the object list according to the characteristic datum and utilizing the Euclidean distance rule for tracking the moving object.

10. The method of claim 1 further comprising calculating the amount of the moving objects in the plurality of current images captured in step (b) according to a tracking result generated in step (g) and a classification result generated in step (h).

11. The method of claim 1 further comprising calculating the speed of the moving object according to a tracking result generated in step (g).

12. The method of claim 11, wherein calculating the speed of the moving object according to a tracking result generated in step (g) comprises calculating the speed of the moving object according to the number of the plurality of current images captured between a first location and a second location of the moving object, the distance between the first location and the second location, and the image capturing speed.
